(19) United States
(12) Patent Application Publication
(10) Pub. No.: US 2009/0154042 A1
(43) Pub. Date: Jun. 18, 2009

(54) OVER CURRENT PROTECTION METHOD AND DEVICE

(75) Inventor: Lev Zisman, Jerusalem (IL)

Correspondence Address: Pearl Cohen Zedek Latzer, LLP, 1500 Broadway, 12th Floor, New York, NY, 10036, US

(73) Assignee: SATEC LTD., Jerusalem (IL)

(21) Appl. No.: 11/957,553

(22) Filed: Dec. 17, 2007

(51) Int. Cl. H02H 3/08

(52) U.S. Cl. 361/87

(57) ABSTRACT

An over current protection system, the system includes: a sampling rate unit, adapted to determine a sampling rate of at least one alternating input current in response to an alternating input current cycle duration; and a controller, adapted to receive samples of the at least one alternating input current and to initiate an appliance of an over current protection measure if at least one of the following conditions is fulfilled: an amplitude of an alternating input current exceeds a first threshold before magnitudes of multiple alternating input current samples exceed a second threshold; and magnitudes of multiple alternating input current samples exceed a third threshold, wherein the third threshold exceeds the first and second thresholds.

### FIELD OF THE INVENTION

The present invention relates to methods and devices for over current protection methods and devices.

### BACKGROUND OF THE INVENTION

Over current protection systems and devices are supposed to apply an over current protection measure (such as disconnecting circuit breakers) once a monitored current exceeds a predefined value. A typical over current protection system monitors a current by: (i) sampling the current at a certain predefined fixed sampling rate to provide samples, (ii) calculating the amplitude of the current in response to multiple samples of the current that are obtained during a period that is not shorter than an expected cycle of the current.

The certain predefined fixed sampling rate is set in response to an expected (typical) cycle of the current. It is set in advance and is not changed during the monitoring process.

The mentioned above monitor scheme has two major drawbacks: (i) sampling at the certain predefined fixed sampling rate can provide inaccurate results, as the actual cycle of the current can deviate from the expected cycle; and (ii) Calculating the amplitude is lengthy (at least one cycle of the current) and is also susceptible to harmonic induced monitoring error.

It would be very useful to have an accurate and fast over current protection systems and methods.

### SUMMARY OF THE PRESENT INVENTION

An over current protection system, the system includes: a sampling rate unit, adapted to determine a sampling rate of at least one alternating input current in response to an alternating input current cycle duration; and a controller, adapted to receive samples of the at least one alternating input current and to initiate an appliance of an over current protection measure if at least one of the following conditions is fulfilled: an amplitude of an alternating input current exceeds a first threshold before magnitudes of multiple alternating input current samples exceed a second threshold; and magnitudes of multiple alternating input current samples exceed a third threshold, wherein the third threshold exceeds the first and second thresholds.

An over current protection system, the system includes: a controller, adapted to receive samples of the at least one alternating input current and to initiate an appliance of an over current protection measure if at least one of the following conditions is fulfilled: an amplitude of an alternating input current exceeds a first threshold before magnitudes of multiple alternating input current samples exceed a second threshold; and magnitudes of multiple alternating input current samples exceed a third threshold, wherein the third threshold exceeds the first and second thresholds; wherein the controller is adapted to calculate the amplitude of an alternating input current in response to a square of a first derivative of the alternating input current and to a square of the second derivative of the alternating input current.

A method for over current protection, the method includes: sampling at least one alternating input current at a sampling rate that is responsive to an alternating input current cycle; and applying an over current protection measure if at least one of the following conditions is fulfilled: (i) an amplitude of an alternating input current exceeds a first threshold before magnitudes of multiple alternating input current samples exceed a second threshold; (ii) magnitudes of multiple alternating input current samples exceed a third threshold, wherein the third threshold exceeds the first and second thresholds.

### BRIEF DESCRIPTION OF THE DRAWINGS

The present invention will be understood and appreciated more fully from the following detailed description taken in conjunction with the drawings in which:

FIG. 1 is a simplified block diagram of an over current protection system and its environment according to an embodiment of the invention;

FIG. 2 illustrates a method for over current protection according to an embodiment of the invention; and

FIG. 3 illustrates an over current protection algorithm according to an embodiment of the invention.

### DETAILED DESCRIPTION OF THE DRAWINGS

According to various embodiments of the invention systems and methods for over current protection are provided. The sampling rate of an alternating input current is determined based upon the cycle of an alternating input current. The cycle is monitored and changes in that cycle affect the sampling rate. The samples of the alternating input current are processed in order to determine whether to apply an over current protection measure. The determination can be based upon the amplitude of the alternating input current and, additionally or alternatively, upon the magnitudes of one or more samples of the alternating input current. The latter (responding in response to a magnitude or one or more samples) provides an over current protection scheme that can respond within a fraction of a cycle.

Conveniently, an over current protection measure is applied if at least one of the following conditions is fulfilled: (i) an amplitude of an alternating input current exceeds a first threshold before magnitudes of multiple alternating input current samples exceed a second threshold; or (ii) magnitudes of multiple alternating input current samples exceed a third threshold. The third threshold conveniently exceeds the first and second thresholds.

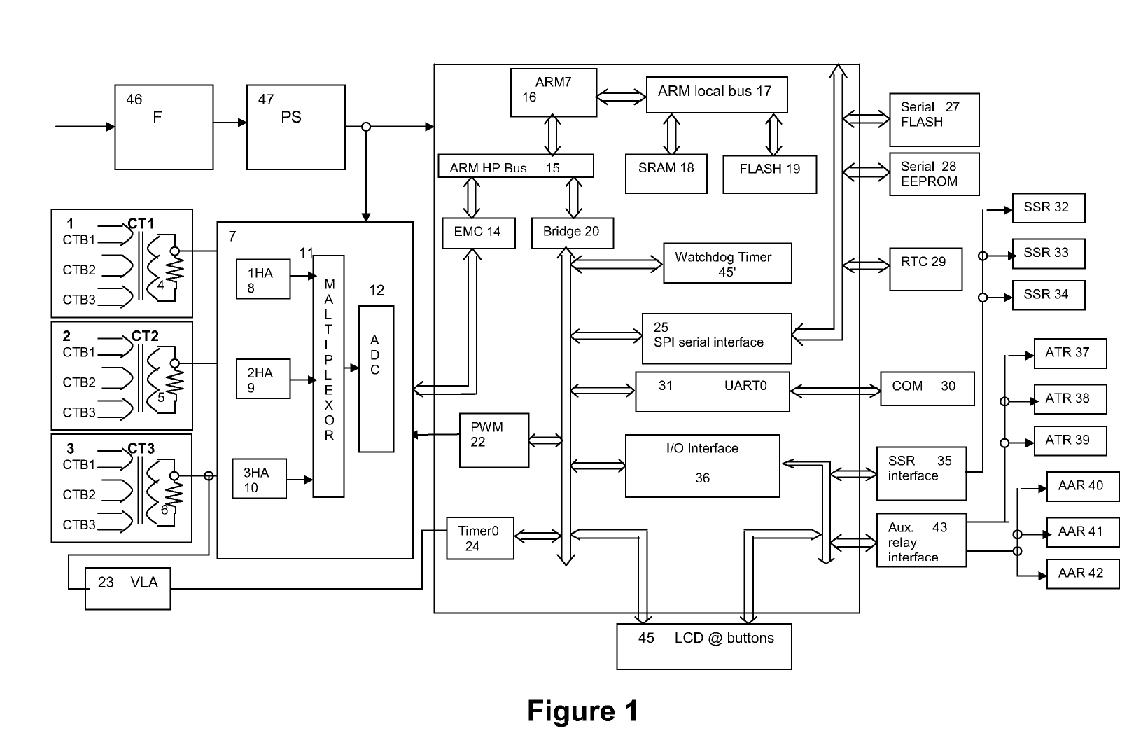

FIG. 1 is a simplified block diagram of an over current protection system 100 and its environment according to an embodiment of the invention.

Over current protection system 100 is connected to three current transformers 1, 2 and 3 and to three resistive loads 4, 5 and 6, respectively, in order to receive three alternating input currents Ia, Ib and Ic.

Ia, Ib and Ic are provided to analog to digital converter (ADC) 7, such as a four channel analog to digital converter of National Semiconductor Inc. ADC 7 includes hold amplifiers 8, 9 and 10, whereas hold amplifier 8 receives Ia, hold amplifier 9 receives Ib and hold amplifier 10 receives Ic. Multiplexer 11 is connected between hogl amplifiers 8, 9 and 10 to a analog to digital conversion unit 12. ADC 7 performs time based multilexing in order to sample each of the alternating input currents Ia, Ib and Ic.

As will illustrated below, the sampling rate is responsive to an alternating current cycle, as measured by voltage limter amplifier 23 and timer 24. Conveniently, the cycle of Ic is monitored, although this is not necessarily so and other alternating input currents can be monitored.

Over current protection system (also referred to as “system”) 100 includes: (i) sampling rate unit 102 that is adapted to determine a sampling rate of at least one alternating input current in response to an alternating input current cycle duration. System 100 also includes over current protection controller 103 that is adapted to receive samples of the at least one alternating input current (Ia, Ib and Ic) and to initiate an appliance of an over current protection measure if at least one of the following conditions is fulfilled: (i) an amplitude of an alternating input current exceeds a first threshold before magnitudes of multiple alternating input current samples exceed a second threshold; or (ii) magnitudes of multiple alternating input current samples exceed a third threshold.

Sampling rate unit 102 includes ADC7, Voltage Limited Amplifier (VLA) 23 and timer. VLA 24 converts an ideally sinusoidal alternating input current (for example current Ic) to a rectangular signal that has a width that represents the cycle of the alternating input current. The width of the rectangular signal is measured by timer 24.

For example, if sixty four samples are required per cycle and the cycle of Ic is twenty milliseconds (Frequency of fifty Hertz) then the sampling rate should be three thousand and two hundred samples per second. If, the cycle of Ic deviates to ( 1/51) Second (frequency of fifty one Hertz) then the sampling rate should be three thousand two hundred and sixty four samples per cycle. It is noted that the sampling rate can be updated based upon one or multiple previously measured cycles. Conveniently, cycle deviations that are below a certain cycle deviation threshold (for example—below two percent) are ignored.

Over current protection controller 103 includes a microprocessor such as ARM 16. It is connected to various memory units and busses that enable the processor to execute an over current protection software code, store data, retrieve data (including alternating input current samples, values of various thresholds and the like) and output data and commands (such as a command to apply an over current protection measure).

FIG. 1 relates to an ARM based architecture. It is noted that other processors can be used without departing from the scope of the invention.

ADC 7 has a parallel output which is connected, via external parallel data bus 13 to External Memory Controller (EMC) 14. EMC 14 is connected to ARM Advanced High Performance Bus 15. ARM Advanced High Performance Bus 15 is also connected to bridge 20 and to ARM 16. ARM 16 is an ARM microprocessor commercially available from Phillips Corporation. ARM 16 is used for controlling transceiver 30, memory units 27 and 28, ADC 7, SRAM 18, output control 17 and bus 18, as dictated by the aforementioned programs stored in FLASH memory unit 19.

ARM 16 is connected via ARM local bus 17 to SRAM 18 and FLASH memory unit 19. SRAM 18 is connectively used for the temporary storage of current information and as a scratch pad memory. FLASH memory unit 19 stores an over current protection code as well as code that supports multiple operational modes of system 100, including but not limited to operational mode, testing mode and setting mode.

Bridge 20 is connected between ARM Advanced High Performance Bus 15 to VLSI Peripheral Bus 21. VLSI Peripheral Bus 21 is connected to watchdog timer 45′, SPI serial interface 25, UART01 31, I/O interface 36, LCD and buttons 45, timer 24 and Pulse Width Modulator (PWM) 22.

SPI serial interface 25 is also connected, via bus 26, to real time clock (RTC) 29, serial Flash memory unit 27 and serial EEPROM memory unit 28. Serial FLASH memory unit 27 is used for event and waveform logging. Serial EEPROM memory unit 28 stores protection control set points (such as various thresholds), which can be modified by command instructions provided from communication port 30. Communication port 30 is connected via Universal Asynchronous Receiver/Transmitter (UART) 31 to VLSI Peripheral Bus 21.

System 100 is connected via Solid State Relay (SSR) interface 35 to Solid State Relays (SSR) SSR1 32, SSR2 33 and SSR3 34 that can trip circuit breakers (not shown) such as to temporarily stop the provision of currents. System 100 is also connected via auxiliary relay interface 35 to Auxiliary Trip Relays (ATR) ATR1 37, ATR2 38 and ATR3 39 and to Auxiliary Alarm Relays (AAR) AAR1 40, AAR2 41 and AAR3 42.

System 100 receives its power supply from power supply unit 47 that is connected to a low pass filter 46.

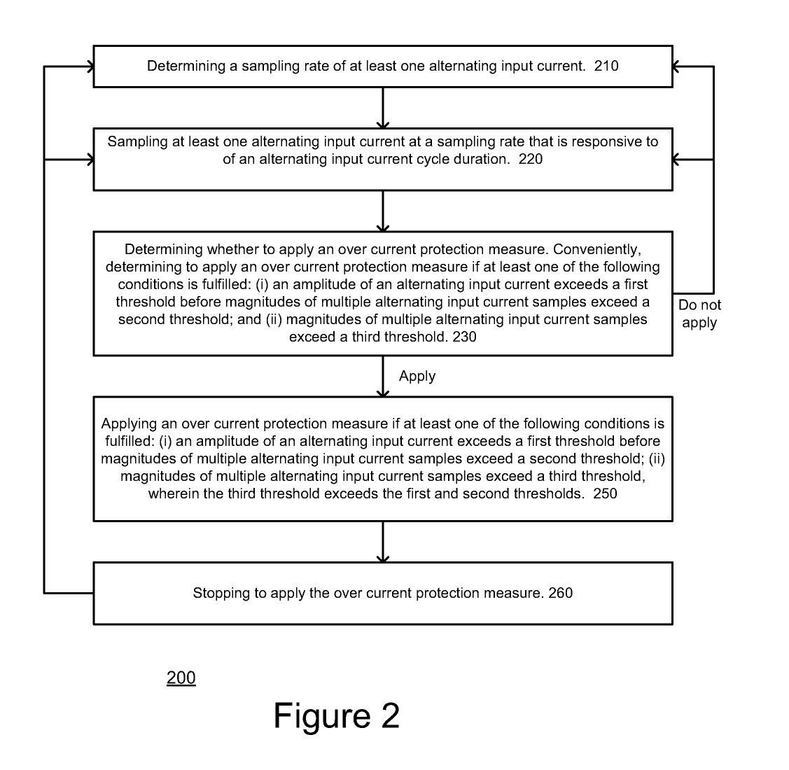

FIG. 2 illustrates method 200 for over current protection, according to an embodiment of the invention.

Method 200 starts by stages 210 and 220. These stages are conveniently executed in a pipelined manner.

Stage 210 includes determining a sampling rate of at least one alternating input current.

Stage 210 is followed by stage 220 of sampling at least one alternating input current at a sampling rate that is responsive to a cycle of the alternating input current.

Stage 220 is followed by stage 230 of determining whether to apply an over current protection measure. In a nut shell, stage 230 includes determining to apply an over current protection measure if at least one of the following conditions is fulfilled: (i) an amplitude of an alternating input current exceeds a first threshold before magnitudes of multiple alternating input current samples exceed a second threshold; and (ii) magnitudes of multiple alternating input current samples exceed a third threshold.

Conveniently, stage 230 includes determining to apply an over current protection measure if a determination that magnitudes of multiple alternating input current samples exceed a second threshold occurs at least a predefined time gap before a determination that an amplitude of an alternating input current exceeds the first threshold.

In relation to the thresholds, at least one of the following conditions is fulfilled: (i) the third threshold exceeds the first and second thresholds, (ii) the second threshold is smaller than the first threshold, (iii) all thresholds are determined in response to an maximal allowable load current that can be provided to a load (not shown), (iv) the first threshold is at least one and a half times bigger than the second threshold, (v) the third threshold is at least one and a half times bigger than the first threshold, (vi) the first threshold is at least three times bigger than the maximal allowable load current, and (vii) the first threshold is not bigger than ten times the maximal allowable load current.

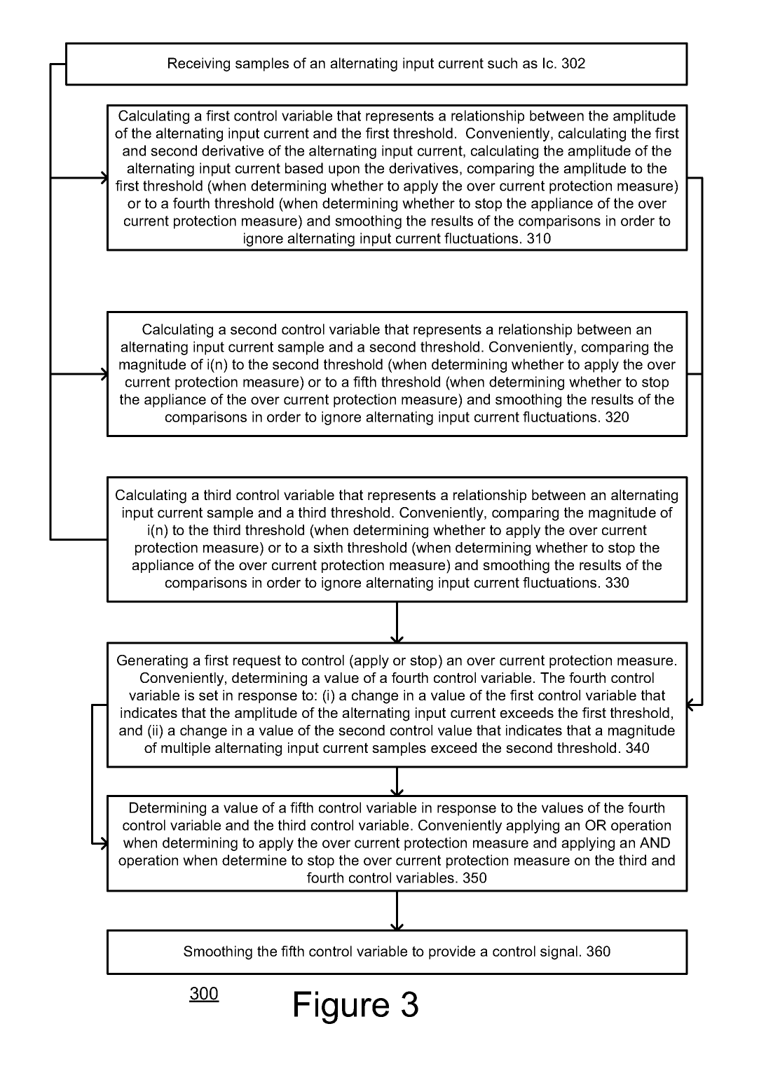

According to an embodiment of an invention stage 230 also includes ignoring alternating input current samples fluctuations. As will be further illustrated in relation to FIG. 3, short changes in a control variable do not affect the determination.

Due to the sinusoidal nature of the input alternating current, decisions relating to stopping the appliance of over current protection measures must take into account the peak values of that current. Thus, decisions to stop the appliance of an over current protection measure should wait (for at least half a cycle) in order to determine whether input alternating current peaks that follow peaks that triggered the appliance of the over current protection range are within an allowable ranges. Accordingly, stages 230, as well as stage 260 of FIG. 2 and stages 310, 320, 330 and 360 of FIG. 3 delay the decision to stop an appliance of an over current protection measure by at least half an alternating input current duration.

Stage 230 can be followed by stages 210, 220 or 250.

Stage 250 includes applying an over current protection measure if at least one of the following conditions is fulfilled: (i) an amplitude of an alternating input current exceeds a first threshold before magnitudes of multiple alternating input current samples exceed a second threshold; (ii) magnitudes of multiple alternating input current samples exceed a third threshold, wherein the third threshold exceeds the first and second thresholds.

Stage 250 includes stage 260 of stopping to apply the over current protection measure. The appliance of an over current protection measure is stopped if multiple so called stopping conditions are fulfilled. A stopping condition can differ from an appliance condition (a condition which was evaluated during stage 230).

Conveniently, stage 260 includes determining to stop applying the over current protection measure if all the following conditions are fulfilled: (i) an amplitude of an alternating input current is below a fourth threshold, (ii) magnitudes of multiple alternating input current samples are below a fifth threshold; and (ii) magnitudes of multiple alternating input current samples are below a sixth threshold.

Conveniently, stage 260 determines to stop an appliance of an over current protection measure in response to alternating input current samples obtained during at least one half of a input current cycle after a determination to apply the over current protection measure. This will assure that at least one input alternating current peak (or near points) will be sampled to determine whether the input alternating current is within an allowable range.

Conveniently, the first threshold can exceed the fourth threshold, the second threshold can exceed the fifth threshold and the third threshold can exceed the sixth threshold. It is noted that the first threshold can equal the fourth threshold (or even can be smaller than the fourth threshold), the second threshold can equal the fifth threshold (or even can be smaller than the fifth threshold), and the third threshold can equal the sixth threshold (or even can be smaller than the sixth threshold).

Stage 260 is followed by stages 210 and 220.

FIG. 3 illustrates over current protection algorithm 300 according to an embodiment of the invention.

Over current protection algorithm 300 can be executed by over current protection controller 103 and includes stages 230 and 260 of method 200.

Over current protection algorithm 300 starts by stage 302 of receiving samples of an alternating input current such as Ic. The latest sample is denoted i(n) Older samples are represented by their relative distance from i(n). Thus, i(n) is preceded by i(n−1) that in turn is preceded by (n−2) and so on. These samples can be low pass filtered.

Stage 302 is followed by stages 310, 320 and 330 that include computing three control variables. Stage 310 includes calculating a first control variable that represents a relationship between the amplitude of the alternating input current and the first threshold (or the fourth threshold). Stage 320 includes calculating a second control variable that represents a relationship between an alternating input current sample and the second threshold (or the fifth threshold). Stage 330 includes calculating a third control variable that represents a relationship between an alternating input current sample and the third threshold (or the sixth threshold).

Stages 310, 320 and 330 are followed by stage 250 of determining when to apply an over current protection measure and when to stop the appliance of the over current protection measure.

Stage 310 includes: (i) calculating the first and second derivatives of the alternating input current, (ii) calculating the amplitude of the alternating input current based upon the derivatives, (iii) comparing the amplitude to the first threshold (when determining whether to apply the over current protection measure) or to the fourth threshold (when determining whether to stop the appliance of the over current protection measure) and smoothing the results of the comparisons in order to ignore alternating input current fluctuations.

Conveniently, stage 310 includes solving the following equations:

Δi(n−2)=(i(n)−i(n−4))×2.563.

Δ²i(n−4)=(Δi(n−2)−Δi(n−6))×2.563.

A(n−4)=Δi(n⊕4)×Δi(n−4)+Δ²i(n−4)×Δ²i(n−4).

Wherein Δi(n−2) is the first derivative of the alternating input current at point (n−2). Δ²i(n−4) is the second derivative of the alternating input current as point (n−4). A(n−4) is the alternating input current amplitude at point (n−4). Point (n−2) corresponds to the (n−2)′th sample, point (n−4) corresponds to the (n−4)′th sample and i(n) is the last sample.

When determining whether to apply the over current protection measure (stage 230 of method 200) A is compared to the first threshold and is A is bigger then the first threshold then a first intermediate variable is set.

The comparison is followed by smoothing the results of the comparisons obtained during consecutive points in time. If the first intermediate variable is set for a period that exceeds a first period then a second intermediate variable is set. The second intermediate variable is provided to a smoothing unit that ignores short resets of the second intermediate variable to provide the first control variable.

When determining whether to stop to apply the over current protection measure (stage 260 of method 200) A is compared to the fourth threshold and if A is smaller then the fourth threshold then the first intermediate variable is reset.

The comparison is followed by smoothing the results of the comparisons obtained during consecutive points in time. If the first intermediate variable is reset for a period that exceeds a second period then a second intermediate variable is reset. The second intermediate variable is provided to a smoothing unit that ignores short sets of the second intermediate variable to provide the first control variable.

Stage 320 includes comparing the magnitude of i(n) to the second threshold (when determining whether to apply the over current protection measure) or to a fifth threshold (when determining whether to stop the appliance of the over current protection measure) and smoothing the results of the comparisons in order to ignore alternating input current fluctuations.

When determining whether to apply the over current protection measure i(n) is compared to the second threshold and if the magnitude of i(n) is bigger than the second threshold then a third intermediate variable is set.

The comparison is followed by smoothing the results of the comparisons obtained during consecutive points in time. If the third intermediate variable is set for a period that exceeds a third period then a fourth intermediate variable is set. The fourth intermediate variable is provided to a smoothing unit that ignores short resets of the fourth intermediate variable to provide the second control variable.

When determining whether to stop to apply the over current protection measure (stage 260 of method 200) i(n) is compared to the fifth threshold and if i(n) is smaller then the fifth threshold then the third intermediate variable is reset.

The comparison is followed by smoothing the results of the comparisons obtained during consecutive points in time. If the third intermediate variable is reset for a period that exceeds a fourth period then a fourth intermediate variable is reset. The fourth intermediate variable is provided to a smoothing unit that ignores short sets of the fourth intermediate variable to provide the second control variable.

Stage 330 includes calculating a third control variable that represents a relationship between an alternating input current sample and a third threshold (or a sixth threshold). Conveniently, stage 330 includes comparing the magnitude of i(n) to the third threshold (when determining whether to apply the over current protection measure) or to the sixth threshold (when determining whether to stop the appliance of the over current protection measure) and smoothing the results of the comparisons in order to ignore alternating input current fluctuations.

When determining whether to apply the over current protection measure i(n) is compared to the third threshold and if the magnitude of i(n) is bigger than the third threshold then a fifth intermediate variable is set.

The comparison is followed by smoothing the results of the comparisons obtained during consecutive points in time. If the fifth intermediate variable is set for a period that exceeds a third period then a sixth intermediate variable is set. The sixth intermediate variable is provided to a smoothing unit that ignores short resets of the sixth intermediate variable to provide the third control variable.

When determining whether to stop to apply the over current protection measure (stage 260 of method 200) i(n) is compared to the sixth threshold and if i(n) is smaller then the sixth threshold then the fifth intermediate variable is reset.

The comparison is followed by smoothing the results of the comparisons obtained during consecutive points in time. If the fifth intermediate variable is reset for a period that exceeds a sixth period then the sixth intermediate variable is reset. The sixth intermediate variable is provided to a smoothing unit that ignores short sets of the sixth intermediate variable to provide the third control variable.

Stages 310 and 320 are followed by stage 340. Stage 340 and 330 are followed by stage 350. Stage 350 is followed by stage 360.

Stage 340 includes generating a first request to control (apply or stop) an over current protection measure. Stage 340 includes determining a value of a fourth control variable. The fourth control variable is set in response timing relationship between: (i) a change in a value of the first control variable that indicates that the amplitude of the alternating input current exceeds the first threshold, and (ii) a change in a value of the second control value that indicates that a magnitude of multiple alternating input current samples exceed the second threshold.

Conveniently, the fourth control variable is set if either one of the following condition occur: (i) the first control variable is set before the second control variable is set or (ii) if the second control variable is set at least a predefined time gap before the first control variable is set.

Conveniently, stage 340 prevents over current protection errors during switching-off of the short circuit currents by breakers of the lines. By responding to the timing of changes of the first and second control variables algorithm 300 does not apply the over current protection measure during the switching-off despite the fact that the current decreases instantly from maximum up to zero and derivatives of a current increase in some times for few milliseconds.

Stage 350 includes determining a value of a fifth control variable in response to the values of the fourth control variable and the third control variable. Conveniently, stage 350 includes applying an OR operation when determining to apply the over current protection measure and applying an AND operation when determine to stop the over current protection measure on the third and fourth control variables.

Stage 360 includes smoothing the fifth control variable to provide a control signal. The smoothing can be analogues to the smoothing of stages 310, 320 and 330. While this control signal is set the over current protection measure is applied. While this control signal is reset the over current protection measure is not applied.

Stage 310 provides a response to the amplitude of the alternating input current. Stage 320 and 340 provide a response to magnitudes of one or more samples of the alternating input current ignore errors induced by higher harmonic components of the alternating input current (especially ignoring in rush currents of power transformers or capacitor banks connected to system 100). Stage 330 provides an immediate (fraction of a cycle) response to instantaneous current.

Variations, modifications, and other implementations of what is described herein will occur to those of ordinary skill in the art without departing from the spirit and the scope of the invention as claimed.

Accordingly, the invention is to be defined not by the preceding illustrative description but instead by the spirit and scope of the following claims.

We claim:

1. A method for over current protection, the method comprises:
sampling at least one alternating input current at a sampling rate that is responsive to an alternating input current cycle; and
applying an over current protection measure if at least one of the following conditions is fulfilled: (i) an amplitude of an alternating input current exceeds a first threshold before magnitudes of multiple alternating input current samples exceed a second threshold; (ii) magnitudes of multiple alternating input current samples exceed a third threshold, wherein the third threshold exceeds the first and second thresholds.

2. The method according to claim 1 wherein at least one threshold is set in response to an maximal allowable load current.

3. The method according to claim 1 wherein the applying is preceded by determining whether to apply the over current protection measure; wherein the determining comprises ignoring alternating input current samples fluctuations.

4. The method according to claim 1 wherein the applying is followed by determining whether to stop an appliance of over current protection measure; wherein the determination to stop an appliance of an over current protection measure is responsive to alternating input current samples obtained during at least one half of a input current cycle after a determination to apply the over current protection measure.

5. The method according to claim 1 wherein the applying is preceded by:
calculating a first control variable representative of relationship between an amplitude of the alternating input current and the first threshold;
calculating a second control variable representative of a relationship between an alternating input current sample and the second threshold;
calculating a third control variable representative of a relationship between an alternating input current sample and the third threshold; and
wherein the applying of the over current protection measure is responsive to values of the first and second control variables.

6. The method according to claim 4 wherein the applying is responsive to timing relationship between: (i) a change in a value of the first control variable that indicates that the amplitude of the alternating input current exceeds the first threshold, and (ii) a change in a value of the second control value that indicates that a magnitude of multiple alternating input current samples exceed the second threshold.

7. The method according to claim 1 further comprising applying an over current protection measure if a determination that magnitudes of multiple alternating input current samples exceed a second threshold occur at least a predefined time gap before a determination that an amplitude of an alternating input current exceeds a first threshold.

8. The method according to claim 1 wherein the applying is followed by stopping to apply the over current protection measure if an amplitude of an alternating input current is below a fourth threshold, magnitudes of multiple alternating input current samples are below a fifth threshold; and magnitudes of multiple alternating input current samples are below a sixth threshold; wherein the first threshold exceeds the fourth threshold; wherein the second threshold exceeds the fifth threshold; and wherein the third threshold exceeds the sixth threshold.

9. The method according to claim 1 wherein the first threshold is at least one and a half times bigger than of the second threshold.

10. The method according to claim 1 wherein the third threshold is at least one and a half times bigger than the first threshold.

11. The method according to claim 1 wherein the first threshold is at least three times bigger than a maximal allowable load current.

12. The method according to claim 1 comprising calculating the amplitude of an alternating input current in response to a square of a first derivative of the alternating input current and to a square of the second derivative of the alternating input current

13. An over current protection system, the system comprises:
a sampling rate unit, adapted to determine a sampling rate of at least one alternating input current in response to an alternating input current cycle duration; and
a controller, adapted to receive samples of the at least one alternating input current and to initiate an appliance of an over current protection measure if at least one of the following conditions is fulfilled:
(i) an amplitude of an alternating input current exceeds a first threshold before magnitudes of multiple alternating input current samples exceed a second threshold; and
(ii) magnitudes of multiple alternating input current samples exceed a third threshold, wherein the third threshold exceeds the first and second thresholds.

14. The system according to claim 13 wherein at least one threshold is set in response to a maximal allowable load current.

15. The system according to claim 13 wherein the controller is adapted to determine whether to apply the over current protection measure; wherein the determining comprises ignoring alternating input current samples fluctuations.

16. The system according to claim 13 wherein the controller is adapted to determine whether to stop an appliance of over current protection measure; wherein the determination to stop an appliance of an over current protection measure is responsive to alternating input current samples obtained during at least one half of a input current cycle after a determination to apply the over current protection measure.

17. The system according to claim 13 wherein the controller is adapted to:
calculate a first control variable representative of relationship between an amplitude of the alternating input current and the first threshold;
calculate a second control variable representative of a relationship between an alternating input current sample and the second threshold;
calculate a third control variable representative of a relationship between an alternating input current sample and the third threshold; and
apply the over current protection measure is response to values of the first and second control variables.

18. The system according to claim 17 wherein the controller is adapted to apply the over current protection measure in response to timing relationship between: (i) a change in a value of the first control variable that indicates that the amplitude of the alternating input current exceeds the first threshold, and (ii) a change in a value of the second control value that indicates that a magnitude of multiple alternating input current samples exceed the second threshold.

19. The system according to claim 13 the controller is adapted to apply an over current protection measure if a determination that magnitudes of multiple alternating input current samples exceed a second threshold occurs at least a predefined time gap before a determination that an amplitude of an alternating input current exceeds a first threshold.

20. The system according to claim 13 wherein the controller is adapted to stop to apply the over current protection measure if an amplitude of an alternating input current is below a fourth threshold, magnitudes of multiple alternating input current samples are below a fifth threshold; and magnitudes of multiple alternating input current samples are below a sixth threshold; wherein the second threshold exceeds the fifth threshold; and wherein the third threshold exceeds the sixth threshold.

21. The system according to claim 13 wherein the first threshold is at least one and a half times bigger than the second threshold.

22. The system according to claim 13 wherein the third threshold is at least one and a half times bigger than the first threshold.

23. The system according to claim 13 wherein the first threshold is at least three times bigger than a maximal allowable load current.

24. The system according to claim 13 wherein the controller is adapted to calculate the amplitude of an alternating input current in response to a square of a first derivative of the alternating input current and to a square of the second derivative of the alternating input current.

25. An over current protection system, the system comprises:
a controller, adapted to receive samples of the at least one alternating input current and to initiate an appliance of an over current protection measure if at least one of the following conditions is fulfilled:
(iii) an amplitude of an alternating input current exceeds a first threshold before magnitudes of multiple alternating input current samples exceed a second threshold; and
(iv) magnitudes of multiple alternating input current samples exceed a third threshold, wherein the third threshold exceeds the first and second thresholds;
wherein the controller is adapted to calculate the amplitude of an alternating input current in response to a square of a first derivative of the alternating input current and to a square of the second derivative of the alternating input current.
